(19) United States
(12) Patent Application Publication
(10) Pub. No.: US 2025/0327923 A1
(43) Pub. Date: Oct. 23, 2025

(54) Method and Device for Correcting Error in Movement Data of Object

(71) Applicant: Foundation for Research and Business, Seoul National University of Science and Technology, Seoul (KR)

(72) Inventors: Seung Eun LEE, Seoul (KR); Jin Young SHIN, Seoul (KR); Sang Ho LEE, Seoul (KR); Kwang Hyun GO, Seoul (KR)

(21) Appl. No.: 18/896,054

(22) Filed: Sep. 25, 2024

(30) Foreign Application Priority Data
Oct. 17, 2023 (KR) 10-2023-0138629

(51) Int. Cl. G01S 15/50

(52) U.S. Cl. CPC G01S 15/50

(57) ABSTRACT

An error correction method and an error correction device for correcting an error in movement data of an object are provided. The error correction method includes collecting sensing values corresponding to movement of the object for each data frame, based on a predetermined time interval, grouping continuously collected data frames among data frames corresponding to the collected sensing values, normalizing the sensing values based on a minimum value among the sensing values of each of the grouped data frames, using an error detection model, determining whether a previous sensing value is an error value, based on a current sensing value and the previous sensing value collected at a time earlier than the current sensing value among the normalized sensing values, and when the previous sensing value is the error value, correcting the error value based on normal values that are not the error value among the sensing values.

### CROSS-REFERENCE TO RELATED APPLICATION

This application claims the benefit of Korean Patent Application No. 10-2023-0138629, filed on Oct. 17, 2023, in the Korean Intellectual Property Office, the entire disclosure of which is incorporated herein by reference for all purposes.

### BACKGROUND

### 1. Field of the Invention

One or more embodiments relate to technology of correcting an error in movement data of an object.

### 2. Description of the Related Art

As commercial use of autonomous driving technology emerges, which provides convenience to drivers and allows unmanned transportation services, various studies are being conducted in this regard. Particularly, advanced driver assistance system (ADAS) technologies, a low level of autonomous driving, have been commercialized and applied to vehicles. An ADAS collectively refers to functions for driver convenience such as forward collision-avoidance assist, lane departure prevention assist, safe exit assist, driver attention warning, rear side monitor, lane keeping assist, surround view monitor, rear cross-traffic collision-avoidance assist, and remote smart parking assist. To implement technologies in the ADAS field, various types of sensors are used, such as light detection and ranging (LiDAR) sensors, image sensors, radar sensors, and ultrasonic sensors. Distance and image data received through sensors implement a virtual surrounding environment and based on this implemented virtual surrounding environment, ADAS technology adjusts the speed or direction of a vehicle, stops a vehicle, and assists a driver to provide a convenient driving environment. In autonomous driving technology, like ADAS, LiDAR sensors, image sensors, radar sensors, ultrasonic sensors, inertial measurement sensors, and satellite navigation sensors are used for object recognition and location recognition. The autonomous driving technology allows global and local path planning based on the data received from the sensors. However, these sensors cause errors due to environmental influences such as temperature, humidity, diffuse reflection of an object, and diffraction. Sensor errors that occur inside a vehicle affect driving control of the vehicle, such as an accelerator and brakes, and malfunctions in the driving control of the vehicle may lead to serious accidents while driving. Therefore, errors caused by sensors need to be detected and corrected. To solve this issue, research is being conducted on error correction methods using an advanced triangle method (ATM) and a Kalman filter (KF). In order to overcome limitations of conventional error correction methods, efforts have been made to minimize the influences from temperature, humidity, diffuse reflection, and diffraction on sensors. For example, a method of measuring humidity and temperature, which are the causes of errors, and reflecting them to correct sensor errors is a suitable method of detecting tiny errors caused by humidity or temperature. However, sensors used in the ADAS have a high proportion of errors due to diffraction or diffuse reflection caused by movements of an object or uneven surfaces of objects, and thus, the method is not suitable for correcting such errors. An error correction method using the KF has achieved a higher error correction rate than a method using the ATM, but due to the characteristics of the KF, which may be applied to linear functions, the method has non-linear characteristics, and there is a limitation that data moving irregularly or at high speed may not be completely corrected. Therefore, research needs to be conducted to overcome the limitations of the prior art.

### SUMMARY

According to an aspect, there is provided an error correction method of correcting an error in movement data of an object, the error correction method including collecting sensing values corresponding to movement of the object for each data frame, based on a predetermined time interval, grouping continuously collected data frames among data frames corresponding to the collected sensing values, normalizing the sensing values based on a minimum value among the sensing values of each of the grouped data frames, using an error detection model, determining whether a previous sensing value is an error value, based on a current sensing value and the previous sensing value collected at a time earlier than the current sensing value among the normalized sensing values, and in response to the determination that the previous sensing value is the error value, correcting the error value based on normal values that are not the error value among the sensing values.

The sensing values corresponding to the movement of the object may include information about distance values between the object and a sensor.

The error detection model may be an artificial intelligence model that is configured to calculate a slope between consecutive sensing values among the normalized sensing values and determine that the previous sensing value is the error value when the previous sensing value deviates from the slope by more than a threshold value.

The correcting of the error value may include correcting the error value based on at least one of the normalized sensing values, a slope between consecutive sensing values among the normalized sensing values, and the minimum value.

According to another aspect, there is provided an error correction device for correcting an error in movement data of an object, the error correction device including a sensor configured to collect sensing values corresponding to movement of the object for each data frame, based on a predetermined time interval, a data buffer configured to group continuously collected data frames among data frames corresponding to the collected sensing values, a data preprocessor configured to normalize the sensing values based on a minimum value among the sensing values of each of the grouped data frames, an error detector configured to, using an error detection model, determine whether a previous sensing value is an error value, based on a current sensing value and the previous sensing value collected at a time earlier than the current sensing value among the normalized sensing values, and a data corrector configured to, in response to the determination that the previous sensing value is the error value, correct the error value based on normal values that are not the error value among the sensing values.

The sensing values corresponding to the movement of the object may include information about distance values between the object and a sensor.

The error detection model may be an artificial intelligence model that is configured to calculate a slope between consecutive sensing values among the normalized sensing values and determine that the previous sensing value is the error value when the previous sensing value deviates from the slope by more than a threshold value.

The data corrector may be further configured to correct the error value based on at least one of the normalized sensing values, a slope between consecutive sensing values among the normalized sensing values, and the minimum value.

Additional aspects of embodiments will be set forth in part in the description which follows and, in part, will be apparent from the description, or may be learned by practice of the disclosure.

According to an embodiment, movement detection of an object and data correction may be provided simultaneously in one system without having a separate system of detecting movements of the object and detecting errors.

According to an embodiment, data measurement performance of a sensor may be improved and accurate information may be provided in an environment that requires using of object movements.

According to an embodiment, a movement sensor operable in a real environment may be designed and a feedback system of detecting sensor errors and correcting the detected errors may be implemented as a single device.

According to an embodiment, a method of correcting data errors by training an artificial intelligence-based model with only a small amount of data may be provided.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating an overview of an error correction system according to an embodiment;

FIG. 2 is a flowchart illustrating an error correction method according to an embodiment;

FIG. 3 is a diagram illustrating an error correction method according to an embodiment; and

FIG. 4 is a diagram illustrating a configuration of an error correction device according to an embodiment.

### DETAILED DESCRIPTION

The following detailed structural or functional description is provided as an example only and various alterations and modifications may be made to the embodiments. Accordingly, the embodiments are not construed as limited to the disclosure and should be understood to include all changes, equivalents, and replacements within the idea and the technical scope of the disclosure.

Although terms, such as first, second, and the like are used to describe various components, the components are not limited to the terms. These terms should be used only to distinguish one component from another component. For example, a first component may be referred to as a second component, and similarly the second component may also be referred to as the first component.

It should be noted that if one component is described as being “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which the present disclosure pertains. Terms, such as those defined in commonly used dictionaries, should be construed to have meanings matching with contextual meanings in the relevant art, and are not to be construed to have an ideal or excessively formal meaning unless otherwise defined herein.

Hereinafter, embodiments will be described in detail with reference to the accompanying drawings. When describing the embodiments with reference to the accompanying drawings, like reference numerals refer to like components and a repeated description related thereto will be omitted.

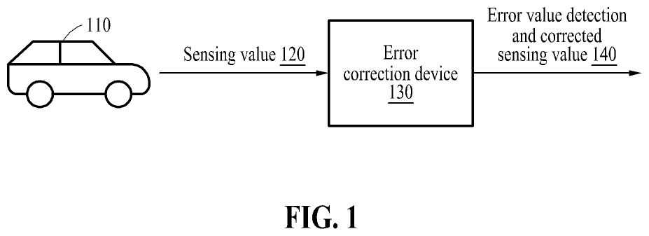

FIG. 1 is a diagram illustrating an overview of an error correction system according to an embodiment.

The error correction system described in the present disclosure uses an artificial intelligence-based model to identify movement of an object and proposes an error correction method to correct errors in collected sensing values based on the movement of the object. The error correction system may identify movement of an object using artificial intelligence with only a small amount of data and may initiate an error correction method of correcting errors in sensing values collected from the movement of the object.

Referring to FIG. 1, the error correction system may include an error correction device 130. The error correction device 130 may collect sensing values 120 corresponding to movement of an object 110 for each data frame, based on a predetermined time interval. The error correction device 130 may group continuously collected data frames among data frames corresponding to the sensing values 120 and may normalize the sensing values 120 based on the minimum value among the sensing values of each of the grouped data frames. Using an error detection model, the error correction device 130 may determine whether a previous sensing value is an error value, based on a current sensing value among the normalized sensing values and the previous sensing value collected at a time earlier than the current sensing value. When the previous sensing value is the error value, the error correction device 130 may detect the error value and may generate a corrected sensing value 140 by correcting the error value based on normal values that are not the error value among the sensing values 120.

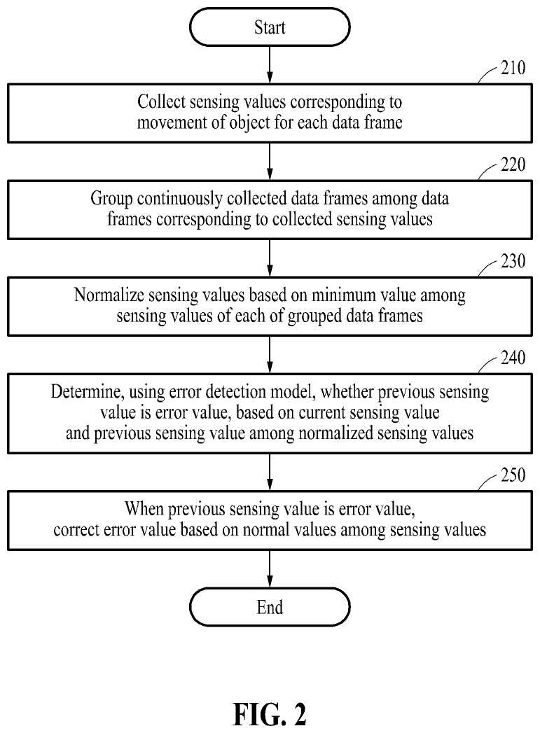

FIG. 2 is a flowchart illustrating an error correction method according to an embodiment.

Referring to FIG. 2, in operation 210, an error correction device may collect sensing values corresponding to movement of an object for each data frame, based on a predetermined time interval. Here, the sensing values corresponding to the movement of the object may include information about distance values between the object and a sensor. That is, the error correction device may collect a sensing value corresponding to the movement of the object including information about a distance value between the object and the sensor. A data frame may be a unit for distinguishing each of the sensing values collected based on the predetermined time interval. That is, each of the sensing values collected based on the predetermined time interval may correspond to each data frame. In another embodiment, the error correction device may determine whether the collected sensing values have a valid bit length and may collect only the sensing values having a valid bit length.

In operation 220, the error correction device may group continuously collected data frames among data frames corresponding to the collected sensing values. That is, for example, when the predetermined time interval is 1 second, the error correction device may group, into one group, a data frame corresponding to a sensing value collected in 1 second, a data frame corresponding to a sensing value collected in 2 seconds, a data frame corresponding to a sensing value collected in 3 seconds, and a data frame corresponding to a sensing value collected in 4 seconds. In this example, the predetermined time interval is 1 second and the four data frames are grouped into one group, but this is only an example for description and the present disclosure is not limited thereto. When there is a new sensing value collected later than the sensing values corresponding to the continuously collected data frames, the error correction device may exclude, from the group, a data frame corresponding to the earliest-collected sensing value and may add, to the group, a data frame corresponding to the new sensing value. This process may be repeated continuously. In another embodiment, the error correction device may group, into one group, data frames corresponding to sensing values continuously stored in a data buffer.

The error correction device may group the continuously collected data frames into one group and may derive a correlation between data frames by overlapping the sensing values of the continuously collected data frames grouped into one group. In the present disclosure, a group may also be referred to as a frame buffer, a set, or a bundle. The movement of the object may show relative similarity within a predetermined range. Even if the sensing value, or more specifically the distance value, is different, data representing the movement of the object may show a similar distribution and may show a consistent pattern. Since an error detection model is based on an artificial intelligence model, there may need to be a correlation between data, that is, between the sensing values, on a time axis in order to identify the movement of the object. The error correction device may derive the correlation by associating between a current sensing value and a previous sensing value. Here, the expression of deriving a correlation may also be interpreted as generating a correlation, detecting a correlation, or analyzing a correlation. In addition, the correlation may also be referred to as an association. For example, the sensing values may be coordinated based on the time at which the sensing values are collected. More specifically, the sensing values may be displayed in a graph having the x-axis as collection time and the y-axis as the sensing value. The correlation between the sensing values may be derived based on the x-axis, which represents time. By deriving such a correlation, the error correction device may analyze the movement of the object based on the sensing value including information about the distance values between the object and the sensor. More specifically, the error correction device may analyze the movement of the object using only the sensing values by deriving the correlation.

In operation 230, the error correction device may normalize the sensing values based on the minimum value among the sensing values of each of the grouped data frames. The error correction device may normalize the sensing values based on the minimum value to recognize a relative difference between the minimum value among the sensing values of each of the grouped data frames and the remaining sensing values among the sensing values of each of the grouped data frames. For example, the error correction device may normalize the sensing values by subtracting, from each of the sensing values, the minimum value among the sensing values of each of the grouped data frames. Accordingly, the normalized sensing values may be converted into data implying characteristics of relative distance.

Through the normalization, the error correction device may normalize various environments that may occur in a range where the object is moving or to be moving. Accordingly, the number of data frames that the error correction device needs to store may be reduced and the amount of training data required for training of the error detection model and the amount of the sensing values required for sensing may be reduced. In other words, the normalization may reduce the amount of data required to correct errors.

In operation 240, the error correction device may determine, using the error detection model, whether a previous sensing value is an error value, based on a current sensing value among the normalized sensing values and the previous sensing value collected at a time earlier than the current sensing value. The error detection model may be an artificial intelligence model that calculates a slope between consecutive sensing values among the normalized sensing values and determines that the previous sensing value is the error value when the previous sensing value deviates from the slope by more than a threshold value. The error correction device may reduce the amount of data required for training the error detection model and the error correction method by normalizing the sensing values.

Distance d (A, B) between A (x1, y1), which represents a group or a set of data frames used as training data, and B (x2, y2), which represents a group or a set of data frames including data frames corresponding to a sensing value recognized in a current system, that is, a current sensing value, may be calculated through Equation 1.

$$d ( A , B ) = \vert x 1 - x 2 \vert + \vert y 1 - y 2 \vert \qquad [ Equation 1 ]$$

In an example, it is assumed that the number of grouped data frames is four and each of the data frames is referred to as a first data frame, a second data frame, a third data frame, and a fourth data frame. In this example, the error detection model may calculate the slope based on at least two of a sensing value corresponding to the first data frame, a sensing value corresponding to the second data frame, and a sensing value corresponding to the fourth data frame. The error correction device may determine whether a sensing value of the third data frame deviates from the slope by more than the threshold value, based on the calculated slope. When the sensing value of the third data frame deviates from the slope by more than the threshold value, the error correction device may determine that the sensing value of the third data frame is the error value. When the sensing value of the third data frame is determined to be the error value, the error correction device may determine a group or a set of data frames as unreasonable data. In addition, when the sensing value of the third data frame is determined to be the error value, the error correction device may determine the error value as noise. On the contrary, when the sensing value of the third data frame is not determined to be the error value, the error correction device may determine a group or a set of data frames as reasonable data. Here, the sensing value corresponding to the third data frame or the sensing value of the third data frame may also be referred to as the previous sensing value. In addition, the sensing value corresponding to the fourth data frame or the sensing value of the fourth data frame may be referred to as the current sensing value. Operations described in this paragraph as being performed by the error correction device may also be performed by the error detection model. In addition, a sensing value and sensing values described after the description of normalization may refer to a normalized sensing value and normalized sensing values.

In operation 250, when the previous sensing value is the error value, the error correction device may correct the error value based on normal values that are not the error value among the sensing values. The error correction device may correct the error value based on at least one of the normalized sensing values, a slope between consecutive sensing values among the normalized sensing values, and the minimum value. In an embodiment, the error correction device may correct the error value based on the slope calculated based on the normal values. The error correction device may correct the error value so that the error value does not deviate from the slope by more than the threshold value. In the present disclosure, the corrected error value may also be referred to as a corrected sensing value or a corrected value.

The error correction device may restore the normalized sensing values including the corrected sensing value (the corrected error value) to original sensing values before the normalization based on the minimum value described above. For example, the original sensing values may be restored by adding the minimum value to each of the normalized sensing values including the corrected sensing value.

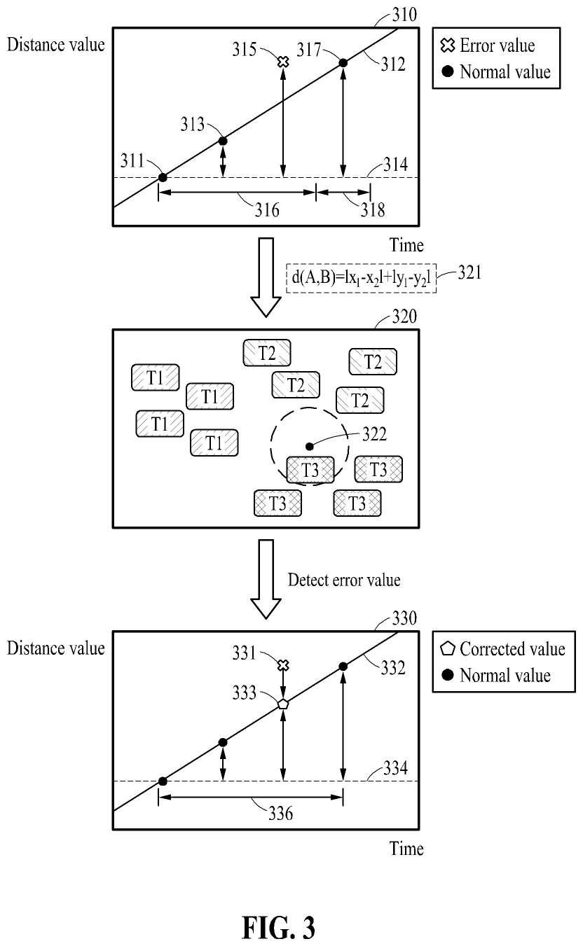

FIG. 3 is a diagram illustrating an error correction method according to an embodiment.

Referring to FIG. 3, a graph 310 may be a graph representing sensing values before an error is corrected. Sensing values 311, 313, 315, and 317 may be sensing values corresponding to each of the data frames grouped into one group. An error correction device may normalize the sensing values 311, 313, 315, and 317 based on a minimum value 314. Reference number 316 may represent overlapping previous sensing values and may correspond to the sensing values 311, 313, and 315. Reference number 318 may represent a current sensing value and may correspond to the sensing value 317. The error correction device may calculate the distance between a group or a set of data frames used as training data and a group or a set of data frames including a data frame corresponding to a sensing value recognized in a current system, that is, the current sensing value, based on x-axis coordinates and y-axis coordinates of at least two of the sensing values 311, 313, 315, and 317. The equation for calculating the distance is reference number 321 and may be the same equation as Equation 1 in the present disclosure. Reference number 312 may be a slope between the sensing values 311, 313, 315, and 317.

A graph 320 may be a graph representing training data for training an error detection model. Each of T1, T2 and T3 may represent training data for training the error detection model. The error correction device may determine whether the sensing value 315 is an error value, based on the graph 320 as well. The sensing value 315 may be a sensing value of one data frame included in a set of data frames corresponding to reference number 322 in the graph 320.

The error correction device may determine whether the error value is included in a group of data frames based on the graph 320. In addition, the error correction device may determine how each of the data frames included in the group tends to move, based on the graph 320. When the sensing value 315 is determined to be an error value 331, that is, when the group including the data frame corresponding to the sensing value 315 is determined to include an error value, the error correction device may correct the error value 331, as shown in a graph 330. The error correction device may correct the error value 331 to be a corrected value 333 to correspond to a slope 332. The error correction device may restore the normalized sensing values to original sensing values by adding a minimum value 334 to corrected values 336.

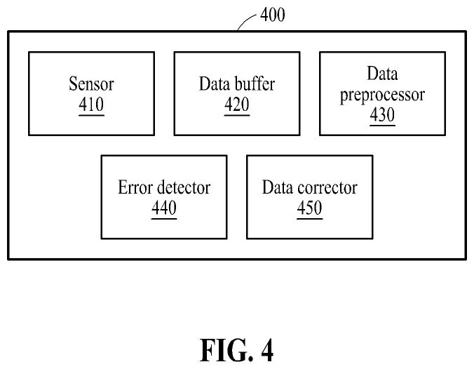

FIG. 4 is a diagram illustrating a configuration of an error correction device according to an embodiment.

Referring to FIG. 4, an error correction device 400 may include a sensor 410, a data buffer 420, a data preprocessor 430, an error detector 440, and a data corrector 450. The error correction device 400 may correspond to the error correction device described in the present disclosure.

The sensor 410 may include an ultrasonic sensor. The sensor 410 may collect sensing values corresponding to movement of an object for each data frame, based on a predetermined time interval. The sensor 410 may collect sensing values having a valid bit length.

The data buffer 420 may group continuously collected data frames among data frames corresponding to the collected sensing values. The data buffer 420 may store the collected sensing values in order in which the sensing values are collected, that is, in chronological order. The data buffer 420 may group data frames corresponding to the sensing values collected continuously in the chronological order. When a new sensing value is collected, the data buffer 420 may remove a data frame corresponding to the earliest-collected sensing value among the grouped data frames and may group data frames including a data frame corresponding to the new sensing value. When the new sensing value is collected, the data buffer 420 may repeat a process of removing the data frame corresponding to the earliest-collected sensing value from the group, storing the data frame corresponding to the new sensing value, and grouping the data frames including the data frame corresponding to the new sensing value.

The data preprocessor 430 may normalize the sensing values based on the minimum value among the sensing values of each of the grouped data frames. For example, the data preprocessor 430 may normalize the sensing values by subtracting, from each of the sensing values, the minimum value among the sensing values of each of the grouped data frames.

By using at least four data frames and normalizing the sensing values, the error correction device may correct an error in the sensing value based on movement of an object with only a small amount of data and lightweighting of artificial intelligence and algorithms for correcting the error in the sensing value may be possible.

Using an error detection model, the error detector 440 may determine whether a previous sensing value is an error value, based on a current sensing value among the normalized sensing values and the previous sensing value collected at a time earlier than the current sensing value.

When the previous sensing value is the error value, the data corrector 450 may correct the error value based on normal values that are not the error value among the sensing values. The data corrector 450 may correct the error value based on at least one of the normalized sensing values, a slope between consecutive sensing values among the normalized sensing values, and the minimum value.

The units described herein may be implemented using hardware components and software components. For example, the hardware components may include microphones, amplifiers, band-pass filters, audio to digital convertors, non-transitory computer memory and processing devices. A processing device may be implemented using one or more general-purpose or special purpose computers, such as, for example, a processor, a controller and an arithmetic logic unit (ALU), a digital signal processor, a microcomputer, a field programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as a parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums. The non-transitory computer readable recording medium may include any data storage device that can store data which can be thereafter read by a computer system or processing device.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. An error correction method of correcting an error in movement data of an object, the error correction method comprising:
collecting sensing values corresponding to movement of the object for each data frame, based on a predetermined time interval;
grouping continuously collected data frames among data frames corresponding to the collected sensing values;
normalizing the sensing values based on a minimum value among the sensing values of each of the grouped data frames;
using an error detection model, determining whether a previous sensing value is an error value, based on a current sensing value and the previous sensing value collected at a time earlier than the current sensing value among the normalized sensing values; and
in response to the determination that the previous sensing value is the error value, correcting the error value based on normal values that are not the error value among the sensing values.

2. The error correction method of claim 1, wherein
the sensing values corresponding to the movement of the object comprise information about distance values between the object and a sensor.

3. The error correction method of claim 1, wherein
the error detection model is an artificial intelligence model that is configured to calculate a slope between consecutive sensing values among the normalized sensing values and determine that the previous sensing value is the error value when the previous sensing value deviates from the slope by more than a threshold value.

4. The error correction method of claim 1, wherein
the correcting of the error value comprises correcting the error value based on at least one of the normalized sensing values, a slope between consecutive sensing values among the normalized sensing values, and the minimum value.

5. An error correction device for correcting an error in movement data of an object, the error correction device comprising:
a sensor configured to collect sensing values corresponding to movement of the object for each data frame, based on a predetermined time interval;
a data buffer configured to group continuously collected data frames among data frames corresponding to the collected sensing values;
a data preprocessor configured to normalize the sensing values based on a minimum value among the sensing values of each of the grouped data frames;
an error detector configured to, using an error detection model, determine whether a previous sensing value is an error value, based on a current sensing value and the previous sensing value collected at a time earlier than the current sensing value among the normalized sensing values; and
a data corrector configured to, in response to the determination that the previous sensing value is the error value, correct the error value based on normal values that are not the error value among the sensing values.

6. The error correction device of claim 5, wherein
the sensing values corresponding to the movement of the object comprise information about distance values between the object and a sensor.

7. The error correction device of claim 5, wherein
the error detection model is an artificial intelligence model that is configured to calculate a slope between consecutive sensing values among the normalized sensing values and determine that the previous sensing value is the error value when the previous sensing value deviates from the slope by more than a threshold value.

8. The error correction device of claim 5, wherein
the data corrector is further configured to correct the error value based on at least one of the normalized sensing values, a slope between consecutive sensing values among the normalized sensing values, and the minimum value.
